(19) United States
(12) Patent Application Publication
(10) Pub. No.: US 2014/0091121 A1
(43) Pub. Date: Apr. 3, 2014

(54) Container and Support Assembly

(71) Applicant: PENGUIN BRANDS, INC., Sharon Hill, PA (US)

(72) Inventors: Bridgit Lombard, Philadelphia, PA (US); Canice Harte, Park City, UT (US); Gregory T Janky, Sammamish, WA (US); Treasure L Hinds, Seattle, WA (US)

(73) Assignee: PENGUIN BRANDS, INC., Sharon Hill, PA (US)

(21) Appl. No.: 13/632,633

(22) Filed: Oct. 1, 2012

(51) Int. Cl. B62J 11/00

(52) U.S. Cl. 224/414; 224/420

(57) ABSTRACT

A combination container and support assembly allows a cyclist to maintain an advantageous aerodynamic position using aerobars while also permitting access to liquid within the container. The support assembly has a body from which pivoting legs extend. Clips at the ends of the legs attach the assembly to the aerobars. A bracket is attached to the body, the bracket holding the container. The container has a streamlined form and has a drinking tube extending therefrom toward the cyclist. A collar is positioned on the container and allows additional accessories to be mounted on the combination.

### FIELD OF THE INVENTION

This invention relates to containers and support assemblies for mounting containers on structures such as aerobars of bicycles.

### BACKGROUND

The use of aerobars on high performance racing bicycles allows the rider to assume and maintain an advantageous aerodynamic position which reduces drag significantly. However, using conventional frame mounted water bottles to replenish lost fluids while riding forces the rider to break the aerodynamic position periodically, resulting in an increase in drag and a consequent loss in performance. There is clearly a need for a liquid container and a support assembly which allow ready access to the liquid by the rider using aerobars while also allowing the rider to maintain the advantageous aerodynamic position.

### SUMMARY

The invention is directed to a support assembly for mounting an item, such as a water bottle, on a structure, such as the aerobars of a bicycle. In one example embodiment, the support assembly comprises a body having a plurality of legs attached to the body and extending outwardly therefrom. A least one of the legs is pivotable relatively to the body. A plurality of clips, are each attached to a respective one of the legs. The clips are adapted to contact the structure and mount the body thereon. A bracket is mounted on the body, the bracket is adapted to receive the item.

In one example, the body has a tapered forward section and a tapered aft section. In another example, at least a first and a second of the legs have respective first and second ends oppositely disposed. The first ends of each of the first and second legs are pivotably attached to the body. The clips are respectively attached to each of the second ends of each of the first and second legs. In one example of the invention, the first and second legs pivot about respective first and second pivot axes. The first and second pivot axes may be oriented parallel to and positioned adjacent to one another. In this example embodiment each of the first and second legs may comprise a plurality of gear teeth respectively positioned on the first ends thereof. The gear teeth on the first leg are in meshing engagement with the gear teeth on the second leg thereby coordinating pivoting motion of the first and second legs about the first and second pivot axes.

In an example embodiment of the invention at least one of the clips comprises an arcuate band. The example invention may further comprise a ball joint positioned between at least one of the legs and one of the clips, the ball joint effecting attachment of the at least one clip to the at least one leg.

In an example embodiment, the bracket comprises a plurality of fingers projecting from the body. The bracket may further comprise, for example, a first and a second finger positioned in spaced relation along a first side of the body and projecting therefrom; a first rail extending between the first and second fingers; a third and a fourth finger positioned in spaced relation along a second side of the body opposite to the first side thereof, the third and fourth fingers projecting from the body; and a second rail extending between the third and fourth fingers.

In another example embodiment, the bracket may comprise a first and a second finger positioned in spaced relation on opposite sides of the body and projecting therefrom. In this example embodiment, the first and second fingers may be attached to the forward section. The bracket may further comprise a third and a fourth finger positioned in spaced relation on opposite sides of the aft section of the body and projecting therefrom. This example embodiment may also include a first rail extending between the first and the third fingers and a second rail extending between the second and fourth fingers.

The invention further encompasses a container for holding a liquid wherein an item is mountable on the container. In one example embodiment, the container comprises a sidewall surrounding and defining an internal volume. The sidewall has an outer surface. A filling port positioned in the sidewall provides access to the internal volume. A tab is mounted on the sidewall and overlies the outer surface. The item is positionable between the tab and the outer surface, and the tab retains the item to the outer surface for mounting the item thereto.

In a particular embodiment, the sidewall comprises a first vessel having a first opening and a second vessel having a second opening. The first and second vessels are joined to one another at the first and second openings and define the internal volume. The container further comprises a collar positioned between the first and second vessels. In one example embodiment, the collar comprises a ring surrounding at least one of the first and second openings of the first and second vessels. The tab is attached to the collar.

In another example embodiment, the first vessel is removably joined to the second vessel. The collar may comprise a ring removably mounted surrounding the opening in one of the first and second vessels, the tab being attached to the collar. In a particular example embodiment, the collar comprises a ring removably mounted surrounding the opening in the second vessel, the tab being attached to the collar.

The container may further comprise a tube mounted on one of the first and second vessels and extending into the internal volume. A sleeve may surround a portion of the tube. In a particular example embodiment, the tube and the sleeve are mounted on the first vessel. In an example embodiment, the filling port is positioned within one of the first and second vessels and a cap is positioned overlying the filling port. In a particular example embodiment, the filling port is positioned within the first vessel and a cap is positioned overlying the filling port. By way of example, the cap may comprise a plurality of flexible leaves which deflect to permit filling of the internal volume through the filling port. The first and second vessels may have an elongate streamlined shape.

Another example embodiment of a container according to the invention comprises a first vessel having a first opening and a second vessel having a second opening. The first and second vessels are joined to one another at the first and second openings and define a fluid holding internal volume. A tube is mounted on one of the first and second vessels. The tube extends into the internal volume. A collar is positioned between the first and second vessels. In a particular example, the collar comprises a ring surrounding the first and second openings of the first and second vessels. A filling port may be positioned within one of the first and second vessels, and a cap is positioned overlying the filling port. In a particular example embodiment, the tube is mounted on the first vessel and the filling port is also positioned within the first vessel. The cap may comprise, for example, a plurality of flexible leaves which deflect to permit filling of the internal volume through the filling port. The example embodiment may also include a sleeve surrounding a portion of the tube, the sleeve being mounted on one of the first and second vessels. The vessels may have an elongate streamlined shape.

In an example embodiment, a tab is attached to the collar and projects therefrom in overlying relation with an outer surface of the container sidewall. The tab is adapted to hold an item against the outer surface of the container.

The first vessel may be removably joined to the second vessel. By way of example, the collar may comprise a ring removably mounted surrounding the opening on one of the first and second vessels. In a particular example, the collar comprises a ring removably mounted surrounding the opening on the second vessel, a tab being attached to the collar and projecting therefrom in overlying relation with an outer surface of the second vessel, the tab adapted to hold an item against the outer surface.

The invention also encompasses the combination comprising a container for holding a liquid and a support assembly for mounting the container on an aerobar of a bicycle. In this example the support assembly may comprise a body with a plurality of legs attached to the body and extending outwardly therefrom. At least one of the legs is pivotable relatively to the body. A plurality of clips is also included, each one of the clips being attached to a respective one of the legs, the clips being adapted to contact the aerobar and mount the body thereon. In this example a bracket is mounted on the body. The bracket is adapted to receive the container. An example container may comprise a first vessel having a first opening and a second vessel having a second opening. The first and second vessels are joined to one another at the first and second openings to defining a fluid holding internal volume. A tube is mounted on one of the first and second vessels. The tube extends into the internal volume. A collar is positioned between the first and second vessels.

### BRIEF DESCRIPTION OF THE DRAWINGS

FIG. 1 is an isometric view of an example embodiment of a combination container and support assembly according to the invention;

FIG. 2 is an isometric view of the support assembly shown in FIG. 1;

FIG. 2A is a bottom view of the support assembly shown in FIG. 2;

FIG. 3 is an exploded isometric view of the support assembly shown in FIG. 2;

FIG. 4 is an exploded isometric view of the example container shown in FIG. 1;

FIG. 5 is an isometric longitudinal sectional view of the container shown in FIG. 4; and

FIG. 6 is an isometric view showing the support assembly mounted on the aerobars of a bicycle.

### DETAILED DESCRIPTION

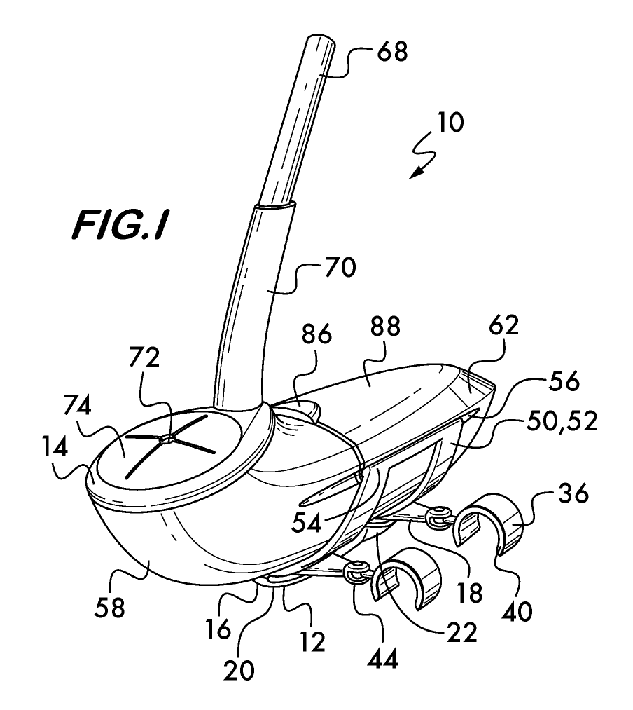

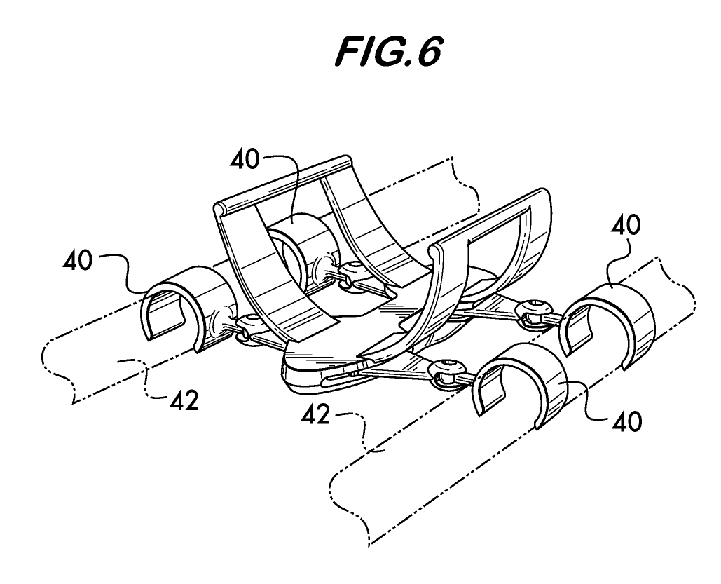

FIG. 1 shows an example combination container and support assembly 10 according to the invention. The combination 10 includes a support assembly 12 adapted to mount on a structure, such as the aerobars of a bicycle (see FIG. 6) and a container 14 which is received and held by the support assembly.

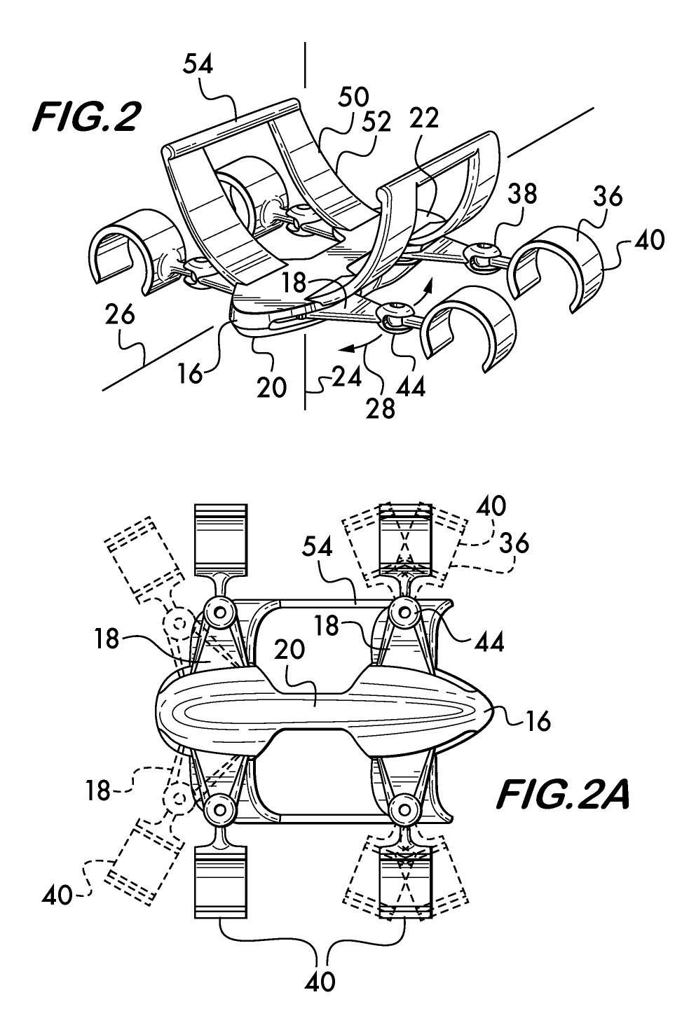

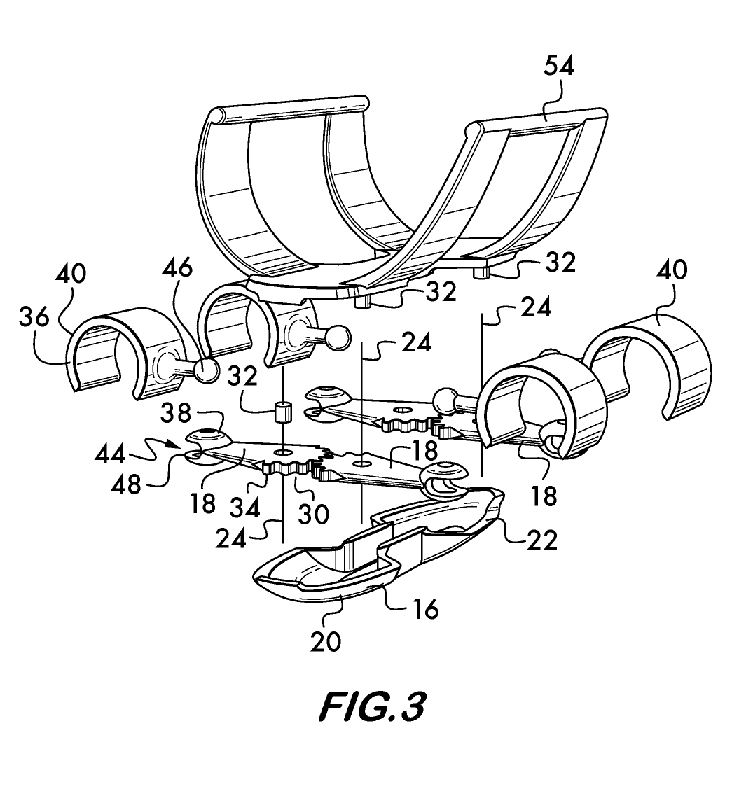

As shown in FIG. 2, support assembly 12 comprises a body 16 on which a plurality of legs 18 are mounted. In this example, body 16 is elongated and has a tapered forward section 20 and a tapered aft section 22 which provides a streamlined shape to the body. Legs 18 extend outwardly from body 16, two being attached to the forward section 20 and two being attached to the aft section 22 in this example. As shown in phantom line in FIG. 2A, at least one of the legs 18 is pivotable relatively to the body. In this example, the pivoting motion is about a pivot axis 24 (see FIG. 2) oriented transversely to the longitudinal axis 26 of the body 16, thereby affording pivoting motion in the fore and aft directions as indicated by double headed arrow 28. In the example embodiment shown, all of the legs 18 are similarly pivotable about respective pivot axes 24, the pivot axes being oriented parallel to one another as shown in FIG. 3. As further shown in FIG. 3, pivoting motion of the legs 18 is afforded by mounting the ends 30 of the legs 18 on axles 32 fixedly mounted within body 16. In this example embodiment, the ends 30 of legs 18 comprise a plurality of gear teeth 34. The legs 18 mounted on the forward section 20 of body 16 have pivot axes 24 adjacent to one another, and the gear teeth 34 on the ends 30 of legs 18 are in meshing engagement with one another, thereby coordinating the pivoting motion of the legs 18 on the forward section with one another. Similarly, the legs 18 mounted on the aft section 22 of body 16 have pivot axes 24 adjacent to one another, and the gear teeth 34 on the ends 30 of legs 18 are in meshing engagement with one another, thereby coordinating the pivoting motion of the legs 18 on the aft section with one another.

As shown in FIG. 2, a clip 36 is mounted on the end 38 of each leg 18. In this example, each clip 36 comprises an arcuate band 40 adapted to contact the structure on which the support assembly is to be mounted. Arcuate bands 40 are advantageously formed of a flexible, resilient material and are sized so that they will deform and resiliently grip the structure on which they are mounted. In a practical example, with reference to FIG. 6, the arcuate bands 40 are sized so that their radius of curvature is slightly smaller than the radius of the aerobars 42, shown in phantom line.

As shown in FIG. 2, it is advantageous to mount the clips 36 to the ends 38 of legs 18 using ball joints 44. As shown in FIG. 3, each ball joint 44 comprises a ball 46 attached to a respective clip 36, and a spherical housing 48 attached to the end 38 of a respective leg 18. As shown in phantom line in FIG. 2A, ball joints 44 permit the clips 36 to pivot relatively to the legs 18. The clips may also rotate about the shaft attaching the ball 46 to the clip 36. The use of pivoting legs 18 and ball joints 44 mounting clips 36 thereto allows the support assembly to be readily adjusted to a variety of aerobars having different bar separation widths and angular orientations. The use of flexible, resilient arcuate bands 40 also improves the versatility of the support assembly, as aerobars having a range of diameters maybe readily accommodated.

As shown in FIG. 2, a bracket 50 is mounted on body 16. Bracket 50 comprises a plurality of fingers 52 which project from the body 16. In the particular example shown, two fingers 52 are attached to the forward section 20 of body 16 on opposite sides thereof, and two fingers 52 are attached to the aft section 22 on opposite sides of the body 16. Rails 54 extend longitudinally between the fingers 52 on each side of the body 16. The fingers 52 and rails 54 comprising the bracket 50 are sized and shaped to receive and retain an item, such as the container 14 as shown in FIG. 1. To this end the fingers 52 may be formed from a flexible, resilient material and the rails 54 spaced apart at a distance slightly less than the width of the container 14. This configuration permits the rails to engage and retain the container 14 when it is received within the bracket 50. It is further advantageous to position a surface feature on opposite sides of the container to facilitate positive mechanical engagement between the bracket and the container. In this example, longitudinal grooves 56 are positioned on opposite sides of the container. The grooves 56 cooperate with the rails 54, which are spring biased into engagement with the grooves by the action of the flexible, resilient fingers 52, to retain the container 14 within the bracket 50.

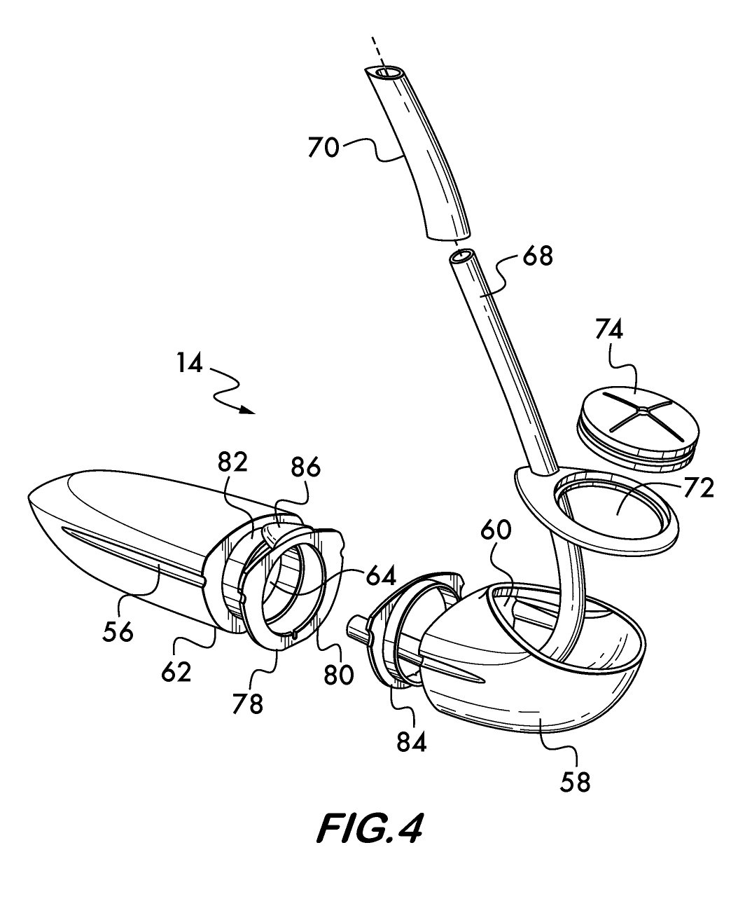

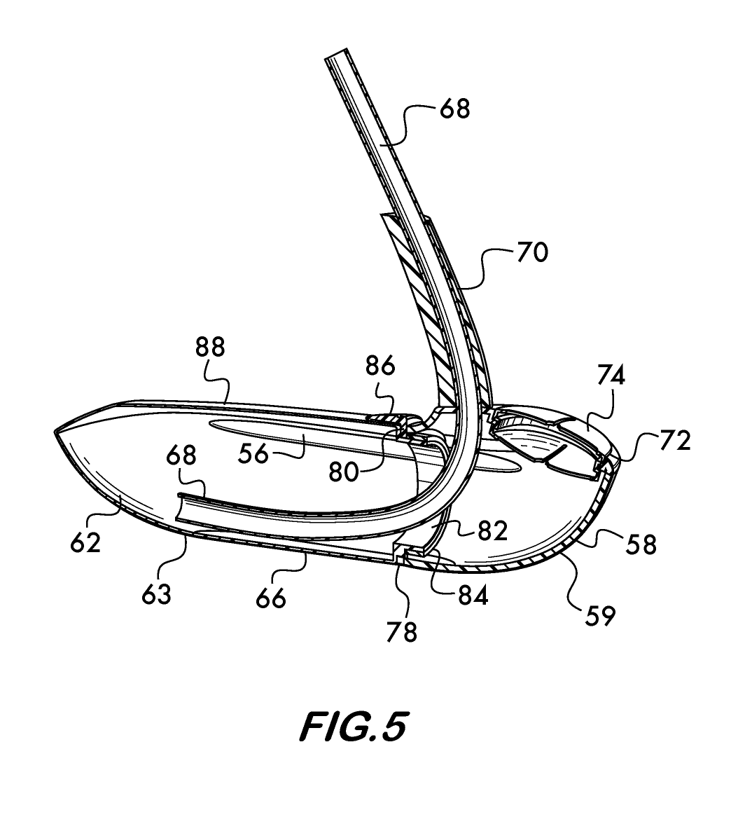

FIGS. 4 and 5 show an example container 14 according to the invention. Container 14 comprises a first vessel 58 having a sidewall 59 with a first opening 60, and a second vessel 62 having a side wall 63 with a second opening 64. The first and second vessels 58 and 62 are joined to one another at their first and second openings 60 and 64 and the sidewalls 59 and 63 thereby define an internal volume 66 as shown in longitudinal section in FIG. 5. In this example the vessels 58 and 62 have an elongate, streamlined shape. A tube 68 is mounted on the container 14, in this example, on the first vessel 58, the tube extending into the internal volume 66 and providing fluid communication thereto. A sleeve 70 is also mounted on the container 14 (in this example on the first vessel 58) and surrounds a portion of the tube 68. Sleeve 70 helps support the tube 68 in an upright configuration, the tube being preferably flexible and thus generally incapable of supporting itself.

A filling port 72 is provided in the container 14. In this example the filling port is positioned within the first vessel 58. A cap 74 is positioned overlying and providing a closure for the filling port. In this example, cap 74 comprises a plurality of flexible leaves 76 which cover the filling port 72 but deflect out of the way when, for example, a nozzle is inserted into the filling port 72 to fill the internal volume 66 with liquid.

As shown in FIGS. 4 and 5, a collar 78 is positioned between the first and second vessels 58 and 62. In this example, the collar 78 comprises a ring 80 which is initially mounted on the second vessel 62 surrounding the second opening 64. When the first and second vessels 58 and 62 are joined at their first and second openings 60 and 64, the ring 80 surrounds both openings 60 and 64. It is advantageous for the collar 78 to be removably mounted on either the first or second vessel, and also that the first and second vessels be removably joined to one another. Removably joining the vessels 58 and 62 to one another may be accomplished in a variety of ways, for example, using mating screw threads, or, as shown by way of example in FIGS. 4 and 5, by a friction fit between an annular extension 82 projecting from the second vessel 62 and surrounding the second opening 64, and a mating fitting 84 positioned on the first vessel 58 and surrounding the first opening 60.

The collar 78 permits additional components to be mounted on the container 14, and making the collar removable allows one to interchange components as desired. In the example embodiment shown in FIGS. 4 and 5, a tab 86 is attached to the collar. Tab 86 projects from the collar 78 in overlying relation with an outer surface 88 of the container 14, in this example, the outer surface 88 being on the second vessel 62. Tab 86 may be used to hold a map or a route cue sheet conveniently atop the container 14 for ready, hands free use by the rider of a bicycle on which the combination 10 is mounted. Alternately, a bracket could be attached to the collar 78. The bracket could be adapted, for example, to hold a cellular telephone or a GPS navigation device for use by the rider.

The combination container and support assembly according to the invention provides a versatile accessory for cyclists using aerobars, the combination having streamlined features for enhanced riding performance.

1. A support assembly for mounting an item on a structure, said support assembly comprising:
a body;
a plurality of legs attached to said body and extending outwardly therefrom, at least one of said legs being pivotable relatively to said body;
a plurality of clips, each one of said clips attached to a respective one of said legs, said clips being adapted to contact said structure and mount said body thereon; and
a bracket mounted on said body, said bracket adapted to receive said item.

2. The support assembly according to claim 1, wherein said body has a tapered forward section and a tapered aft section.

3. The support assembly according to claim 1, wherein at least a first and a second of said legs have respective first and second ends oppositely disposed, said first ends of each of said first and second legs being pivotably attached to said body, said clips being respectively attached to each of said second ends of each of said first and second legs.

4. The support assembly according to claim 3, wherein said first and second legs pivot about respective first and second pivot axes.

5. The support assembly according to claim 4, wherein said first and second pivot axes are oriented parallel to and positioned adjacent to one another.

6. The support assembly according to claim 5, wherein each of said first and second legs comprises a plurality of gear teeth respectively positioned on said first ends thereof, said gear teeth on said first leg being in meshing engagement with said gear teeth on said second leg thereby coordinating pivoting motion of said first and second legs about said first and second pivot axes.

7. The support assembly according to claim 1, wherein at least one of said clips comprises an arcuate band.

8. The support assembly according to claim 1, further comprising a ball joint positioned between at least one of said legs and one of said clips, said ball joint effecting attachment of said at least one clip to said at least one leg.

9. The support assembly according to claim 1, wherein said bracket comprises a plurality of fingers projecting from said body.

10. The support assembly according to claim 1, wherein said bracket comprises:
a first and a second finger positioned in spaced relation along a first side of said body and projecting therefrom;
a first rail extending between said first and second fingers;
a third and a fourth finger positioned in spaced relation along a second side of said body opposite to said first side thereof, said third and fourth fingers projecting from said body;
a second rail extending between said third and fourth fingers.

11. The support assembly according to claim 1, wherein said bracket comprises:
a first and a second finger positioned in spaced relation on opposite sides of said body and projecting therefrom.

12. The support assembly according to claim 11, wherein:
said first and second fingers are attached to said forward section, said bracket further comprising:
a third and a fourth finger positioned in spaced relation on opposite sides of said aft section of said body and projecting therefrom.

13. The support assembly according to claim 12, further comprising:
a first rail extending between said first and said third fingers; and
a second rail extending between said second and fourth fingers.

14. A support assembly for mounting an item on a structure, said support assembly comprising:
an elongate body extending along a longitudinal axis and having a forward section and an aft section;
first and second legs projecting outwardly from said forward section;
third and fourth legs projecting outwardly from said aft section;
a respective clip attached to an end of each said leg, said clips being adapted to contact said structure and mount said body thereto; and
a bracket mounted on said body, said bracket adapted to receive said item.

15. The support assembly according to claim 14, wherein said legs are pivotably mounted on said body.

16. The support assembly according to claim 14, wherein said first and second legs are pivotable about respective first and second axes.

17. The support assembly according to claim 16, wherein said first and second axes are oriented transversely to said longitudinal axis.

18. The support assembly according to claim 16, wherein said first and second axes are arranged parallel to one another.

19. The support assembly according to claim 18, wherein each of said first and second legs comprises a plurality of gear teeth positioned on a first end thereof, said gear teeth on said first leg being in meshing engagement with said gear teeth on said second leg thereby coordinating pivoting motion of said first and second legs about said respective first and second axes.

20. The support assembly according to claim 14, wherein said third and fourth legs are pivotable about respective third and fourth axes.

21. The support assembly according to claim 16, wherein said third and fourth axes are oriented transversely to said longitudinal axis.

22. The support assembly according to claim 16, wherein said third and fourth axes are arranged parallel to one another.

23. The support assembly according to claim 22, wherein each of said third and fourth legs comprises a plurality of gear teeth positioned on a first end thereof, said gear teeth on said third leg being in meshing engagement with said gear teeth on said fourth leg thereby coordinating pivoting motion of said third and fourth legs about said respective third and fourth axes.

24. The support assembly according to claim 14, further comprising a ball joint positioned between at least one of said clips and one of said legs, said ball joint effecting attachment of said at least one clip to said one leg.

25. The support assembly according to claim 14, wherein at least one of said clips comprises an arcuate band.

26. The support assembly according to claim 14, wherein said bracket comprises:
a first and a second finger positioned in spaced relation on opposite sides of said body and projecting therefrom.

27. The support assembly according to claim 26, wherein:
said first and second fingers are attached to said forward section, said bracket further comprising:
a third and a fourth finger positioned in spaced relation on opposite sides of said aft section of said body and projecting therefrom.

28. The support assembly according to claim 27, further comprising:
a first rail extending between said first and said third fingers; and
a second rail extending between said second and fourth fingers.

29-54. (canceled)

55. In combination, a container for holding a liquid and a support assembly for mounting said container on an aerobar of a bicycle, said support assembly comprising:
a body;
a plurality of legs attached to said body and extending outwardly therefrom, at least one of said legs being pivotable relatively to said body;
a plurality of clips, each one of said clips attached to a respective one of said legs, said clips being adapted to contact said structure and mount said body thereon; and
a bracket mounted on said body, said bracket adapted to receive said container; said container comprising:
a first vessel having a first opening;
a second vessel having a second opening, said first and second vessels being joined to one another at said first and second openings and defining an internal volume;
a tube mounted on one of said first and second vessels and extending into said internal volume; and
a collar positioned between said first and second vessels.

56. In combination, a container for holding a liquid and a support assembly for mounting said container on an aerobar of a bicycle, said support assembly comprising:
an elongate body extending along a longitudinal axis and having a forward section and an aft section;
first and second legs projecting outwardly from said forward section;
third and fourth legs projecting outwardly from said aft section;
a respective clip attached to an end of each said leg, said clips being adapted to contact said structure and mount said body thereto; and
a bracket mounted on said body, said bracket adapted to receive said container; said container comprising:
a first vessel having a first opening;
a second vessel having a second opening, said first and second vessels being joined to one another at said first and second openings and defining an internal volume;
a tube mounted on said first vessel and extending into said internal volume; and
a collar positioned between said first and second vessels.
